(19) United States
(12) Patent Application Publication
(10) Pub. No.: US 2008/0172269 A1
(43) Pub. Date: Jul. 17, 2008

(54) BUSINESS INTELLIGENCE FRAMEWORK

(75) Inventors: Sunil SENAN, Bangalore (IN); Nitin G. METRI, Bangalore (IN); Varun BABBAR, Bangalore (IN); Gaonkar K. P., Bangalore (IN)

Correspondence Address: WORKMAN NYDEGGER, 60 EAST SOUTH TEMPLE, 1000 EAGLE GATE TOWER, SALT LAKE CITY, UT, 84111, US

(73) Assignee: INFOSYS TECHNOLOGIES LIMITED, Bangalore (IN)

(21) Appl. No.: 11/927,786

(22) Filed: Oct. 30, 2007

(30) Foreign Application Priority Data
Oct. 30, 2006 (IN) 1974/CHE/2006

(51) Int. Cl. G06Q 10/00

(52) U.S. Cl. 705/7

(57) ABSTRACT

A framework for implementing Business Intelligence (BI) solutions at an organization level is provided. The framework includes an architecture module, a process module, an operations and support module, a governance module and a delivery module. The architecture module includes an execution architecture, an operations architecture and a development architecture. The process module manages processes implemented by Business Units (BUs) to provide BI solutions. The operations and support module manages the infrastructural requirements of the framework. The governance module manages the organizational requirements related to the implementation of the framework. The delivery module manages the delivery of the processed business data to the BUs. The process module, the operations and support module, the governance module and the delivery module are implemented, based on the architecture module. The framework is used as a Business Intelligence Competency Center (BICC) for providing real-time BI solutions to BUs.

### BACKGROUND

The invention relates generally to Business Intelligence (BI). More specifically, the invention relates to a framework for implementing BI at an organization level.

Business Intelligence (BI) refers to tools and technologies for collecting, storing and analyzing available data about an organization's operations. This helps it to make improved, timely and optimal business decisions. For example, BI can be used for decision-making in areas such as market research, product profitability, inventory tracking, customer profiling, and the like. Implementing BI requires data related to different factors that affect the operations of the organization or business unit (BU) in the organization, for example, data about customers, competitors and business partners, financial information, details of internal operations, and the like. Typically, BI is implemented through activities such as data sourcing, data warehousing, data analysis, data forecasting, and the like. Different BI solutions are implemented by using technologies provided by products such as SAP-BW, Oracle BI, Seibel Analytics, and the like.

However, currently, the different business units (BUs) of an organization implement its BI solutions in isolation to each other. In other words, their BI solutions are implemented at a project level or a BU level but not at the organization level. Hence, one BU may not be aware of the operations of another BU in the same organization. This not only results in redundant work across the Bus, but also long delivery cycles for providing BI solutions. Further, since no standard guidelines, processes, Service Level Agreements (SLAs), templates and methodologies are adhered to, reusability and sharing of data, resources and initiatives across the BUs is negligible. Known methods or frameworks for implementing BI at the organization level do not take into consideration objectives and requirements at the project or BU level. Moreover, every BU has its own objectives and requirements pertaining to information, which may cause a conflict between the objectives of the organization with those of the BUs. Furthermore these frameworks only offer an execution architecture that provides a BI solution. The frameworks do not provide supporting architectures that are required to facilitate the smooth functioning of the execution architecture. This results in a high Total Cost of Ownership (TCO), which causes budget-related issues. Further, the lack of alignment of objectives between the project level, the BU level and the organization level results in issues related to governance and efficiency. This affects the technology road map of the organization and the stakeholders of the BI are not able to function in consensus.

In light of the foregoing, there is a need for a business-oriented competency framework to provide BI solutions at the organization level, while taking into consideration the requirements at the BU and project level. Further, the framework needs to be scalable and flexible to keep pace with changing requirements in the organization.

### SUMMARY

An object of the invention is to provide a centralized framework for providing BI solutions at an organization level.

Another object of the invention is to reduce the Total Cost of Ownership (TCO) of implementing the centralized framework.

Another object of the invention is to provide effective knowledge sharing and training across the organization.

Another object of the invention is to provide standard tools, templates and methodologies for providing BI solutions.

Yet another object of the invention is to reduce delivery cycles for providing BI solutions.

Yet another object to the invention is to provide a comprehensive and integrated approach to providing the BI solutions.

To achieve the objectives mentioned above, the invention provides a framework for managing the BI solutions of an organization. The organization may include a plurality of Business Units (BUs). The framework includes an architecture module, a process module, an operations and support module, a governance module and a delivery module. The architecture module defines the framework at the organization level. The architecture module includes an execution architecture, an operations architecture and a development architecture. The execution architecture defines the guidelines and methodologies for processing business data, taking into account the organization's policies and the requirements of the BUs. Further, it processes business data to transform it into useful information. The operations architecture defines procedures and policies for processing the requirements of the BUs. The development architecture facilitates the deployment of the framework, based on the requirements of the BUs.

The process module manages the processes implemented by the BUs for providing BI solutions. The processes are managed, based on the architecture module. The process module also includes a Knowledge Management (KM) module for managing knowledge associated with the framework. The operations and support module manages the infrastructural requirements of the framework, based on the architecture module. The governance module manages organizational requirements related to the implementation of the framework. The organizational requirements are managed, based on the architecture module. The delivery module manages the delivery of the processed business data to the BUs. The processed business data is delivered, based on the architecture module.

Accordingly, the framework facilitates the integration of the functioning of organizational, architecture, process, operations and support models. Examples of organizational models may include, but are not limited to, governance, strategy, alignment, engagement, training and funding models. Examples of architecture models may include, but are not limited to, execution, operations and development models. Examples of process models may include, but are not limited to, delivery, framework, quality control, BI consulting, BI solution design, process management, operations and support, project management, knowledge management, scope management and change management models. Examples of operations and support models may include, but are not limited to, testing, deployment, and upgrades and maintenance models.

Further, the framework provides an optimal way of providing BI solutions and reduces the Total Cost of Ownership (TCO) of implementing the framework. Further, the framework is implemented at the organization level by taking into consideration objectives and requirements at a project level as well as a BU level. Furthermore, the framework facilitates effective knowledge-sharing and training across the organization.

### BRIEF DESCRIPTION OF THE DRAWINGS

Various embodiments of the invention will hereinafter be described in conjunction with the appended drawings, provided to illustrate and not to limit the invention, wherein like designations denote like elements, and in which:

FIG. 1 is a block diagram of an architecture for managing Business Intelligence (BI) at an organization level, in accordance with an embodiment of the invention;

FIG. 2 is a block diagram of an architecture for managing Business Intelligence (BI) at an organization level, in accordance with another embodiment of the invention;

FIG. 3 is a block diagram of a framework for managing Business Intelligence (BI) at an organization level, in accordance with an embodiment of the invention;

FIG. 4 is a block diagram of a framework for managing Business Intelligence (BI) at an organization level, in accordance with another embodiment of the invention;

FIG. 5 is an exemplary template, in accordance with an embodiment of the invention; and

FIG. 6 is a block diagram illustrating the implementation of a framework for managing Business Intelligence (BI) at an organization level, in accordance with an embodiment of the invention.

### DETAILED DESCRIPTION OF THE DRAWINGS

The invention provides a framework for managing Business Intelligence (BI) of an organization or enterprise. The organization includes a plurality of Business Units (BUs). The framework may be used to implement BI at an organization level, taking into consideration the information requirements and objectives of the organization at a project and BU level. The framework provides an optimal way of providing a BI solution.

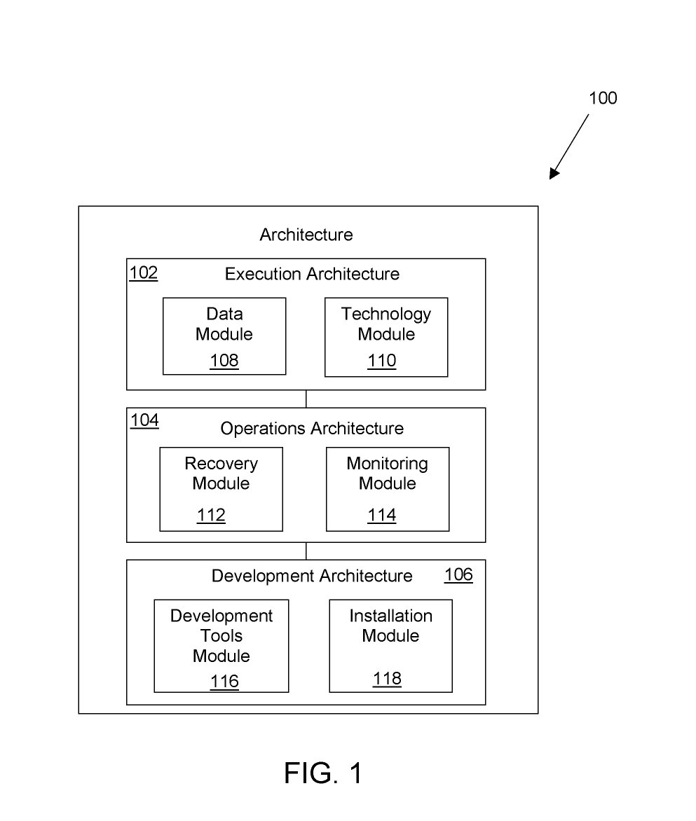

FIG. 1 is a block diagram of an architecture 100 for managing Business Intelligence (BI), in accordance with an embodiment of the invention. BI is implemented by using architecture 100 at an organization level. Architecture 100 defines a set of processes, guidelines and methodologies to streamline BI implementation. Architecture 100 also defines long-term architectural direction at the organization level.

Architecture 100 includes an execution architecture 102, an operations architecture 104 and a development architecture 106. Execution architecture 102 includes a data module 108 and a technology module 110. Operations architecture 104 includes a recovery module 112 and a monitoring module 114. Development architecture 106 includes a development tools module 116 and an installation module 118.

Execution architecture 102 refers to the components of architecture 100, which are accessible to a user, e.g., reporting and analysis tools, interfaces, business reports, and the like. Execution architecture 102 defines methodologies, templates and technologies to process business data, based on the requirements of the BUs. Further execution architecture 102 provides the BI solution by using the processed business data. Examples of business data may include, but are not limited to, financial, technical product, customer, competitor and employee data and the operational details of a BU.

Data module 108 manages business data for providing the BI solution. Managing business data may include, but is not limited to, defining the sources of business data, the information requirements of the Bus, and enabling access to business data. Moreover, data module 108 defines frameworks and guidelines for processing or transforming business data into useful information. In accordance with an embodiment of the invention, data module 108 also identifies the BI tools required for processing business data. Examples of such BI tools may include, but are not limited to, business analytic, business warehousing and data-mining applications. Data module 108 processes business data by using different technology platforms.

Technology module 110 defines technology platforms for implementing architecture 100. Examples of such technology platforms may include, but are not limited to, On-line Analytical Processing (OLAP), Extract Transform Load (ETL), Enterprise Application Interfaces (EAI), Enterprise Information Interfaces (EII), and operating systems, networks, interfaces and relational databases required to implement architecture 100. The technology platforms may be defined, based on the requirements of the BUs as well Information Technology (IT) policies of the organization. In accordance with an embodiment of the invention, the technology platforms are defined after identifying the information requirements of architecture 100.

Operations architecture 104 defines procedures and policies to manage the operations required for providing the BI solution. These procedures and policies are defined in accordance with execution architecture 102. Examples of managing such operations may include, but are not limited to, providing backup and recovery procedures and monitoring usage of architecture 100. Recovery module 112 provides backup and recovery procedures for business data and the BI solution. Monitoring module 114 tracks parameters related to the usage of architecture 100. Examples of these parameters may include, but are not limited to, the usage and response time of the different modules. Further, monitoring module 114 generates security-related alerts for architecture 100. These security-related alerts may be used to prevent and detect malfunctioning of architecture 100. For example, alerts may be generated in the event of a system breakdown, virus attacks and unauthorized access to business data.

Execution architecture 102 and operations architecture 104 function in conjunction with development architecture 106. Development architecture 106 facilitates the deployment of architecture 100, based on the requirements of the BUs. Examples of the facilitation of this deployment may include, but are not limited to, standardizing the BI tools and managing the configuration procedures of architecture 100.

Development tools module 116 standardizes the BI tools required to implement the BI solution. Further, development tools module 116 standardizes a Development Environment (DE) such as an Integrated DE (IDE) that is required to facilitate the deployment of architecture 100. Further, development architecture 106 includes installation module 118, which manages the configuration procedures of architecture 100. Examples of such configuration procedures may include, but are not limited to, the installation of BI tools and templates.

In accordance with an embodiment of the invention, architecture 100 is used in organizations with a centralized Information Technology (IT) team.

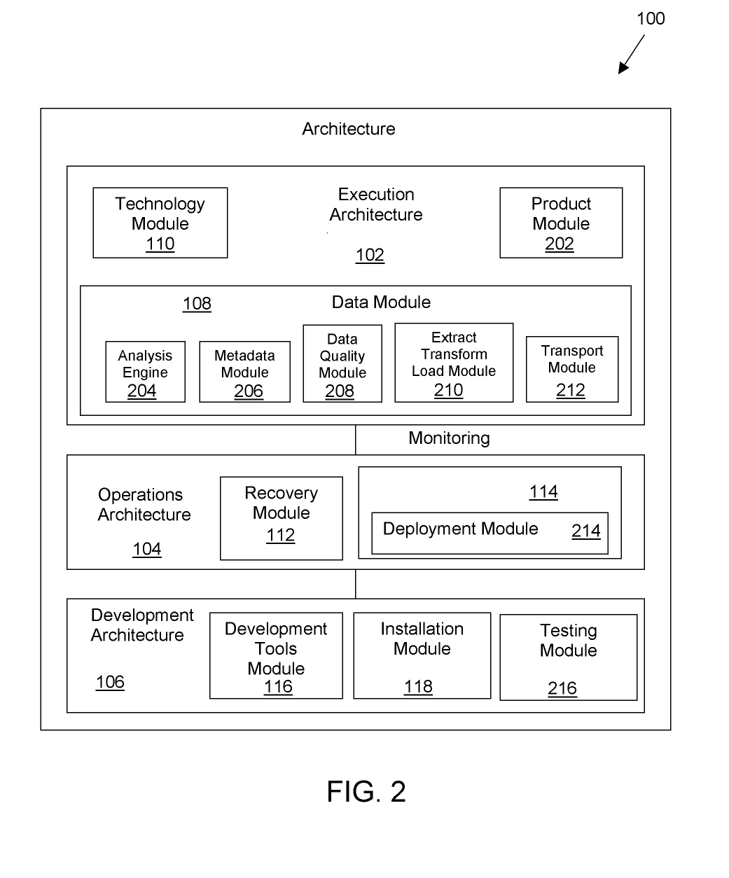

The modules mentioned above, such as data module 108, technology module 110, recovery module 112, monitoring module 114, development tools module 116 and installation module 118, are designed and function according to requirements and objectives at the organization level as well as the BU and project levels. Further, execution architecture 102, operations architecture 104 and development architecture 106 function in conjunction with each other. Each of these modules is explained in detail in conjunction with FIG. 2.

FIG. 2 is a block diagram of architecture 100 for managing Business Intelligence (BI) at an organization level, in accordance with another embodiment of the invention. Architecture 100 includes execution architecture 102, operations architecture 104 and development architecture 106. In addition to data module 108 and technology module 110, execution architecture 102 includes a product module 202. Further, data module 108 includes an analysis engine 204, a metadata module 206, a data-quality module 208, an Extract Transform Load (ETL) module 210, and a transport module 212. Monitoring module 114 of operations architecture 104 includes a deployment module 214 and development architecture 106 also includes a testing module 216.

Data module 108 processes business data to provide the BI solution. Analysis engine 204 analyses the processed business data to generate reports that represent the analysis, based on the requirements of the BUs. Analysis engine 204 provides different business analytics applications that may be used to analyze and report business data. In accordance with various embodiments of the invention, processing and analyzing is performed by using metadata associated with the business data. Metadata module 206 defines the guidelines for acquiring, transforming, integrating, storing and providing the metadata to provide the BI solution. The metadata, for example, may include data related to the business, technical and operational data of the organization. For example, metadata may include a list of the sources of the business data along with timestamps related to the modification of business data. Metadata module 206 also provides information related to how the analysis or the processed business data can be extracted by the user. Analysis engine 204 provides the analysis and processed business data to data quality module 208. Data quality module 208 defines the parameters for evaluating the quality of the analysis and ensuring that the analysis meets the requirements of the BUs and is in line with the organization's policies and procedures.

In accordance with various embodiments of the invention, Extract Transform Load (ETL) module 210 defines the business rules for processing business data and providing the BI solution. Processing business data may include, but is not limited to, creating dimensions for business data, formatting business data, and preparing the content and structure of reports associated with business data. For example, the dimensions are created by integrating the product, customer and employee data of an organization into a single data unit. Further, transport module 212 manages the transportation of business data to provide the BI solution. Transport module 212 defines the procedures for the movement of business data across the BUs in the organization.

In accordance with various embodiments of the invention, product module 202 evaluates different BI products, based on the requirements of the BUs. Product module 202, along with technology module 110, helps the user to select a relevant BI product and technology platform, based on the requirements of the BUs. In accordance with an embodiment of the invention, the BI products are evaluated after defining the information and technology requirements of the organization. Examples of BI products may include, but are not limited to, data-warehousing, data-mining and data-analysis tools.

Deployment module 214 of operations architecture 104 installs and maintains the BI tools required to provide the BI solution. Testing module 216 standardizes testing procedures, based on the requirements of the BUs. This also includes testing procedures for the BI tools.

In accordance with an embodiment of the invention, architecture 100 is used in organizations with multiple decentralized Information Technology (IT) teams.

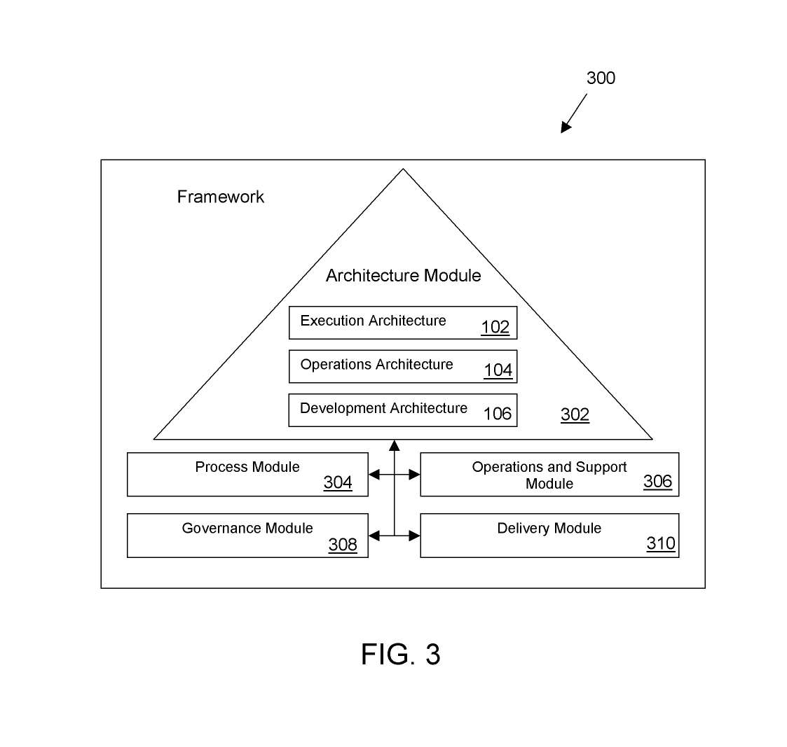

Architecture 100, as described in FIG. 1 and FIG. 2, is integrated with the different functions of the organization and the Bus, to facilitate the strategic management of organization-level applications. This is explained further in conjunction with FIG. 3.

FIG. 3 is a block diagram of a framework 300 for managing Business Intelligence (BI) at an organization level, in accordance with an embodiment of the invention. Framework 300 includes an architecture module 302, a process module 304, an operations and support module 306, a governance module 308, and a delivery module 310. Architecture module 302 includes execution architecture 102, operations architecture 104 and development architecture 106. Architecture module 302 is similar to architecture 100 and has been explained in conjunction with FIG. 1 and FIG. 2.

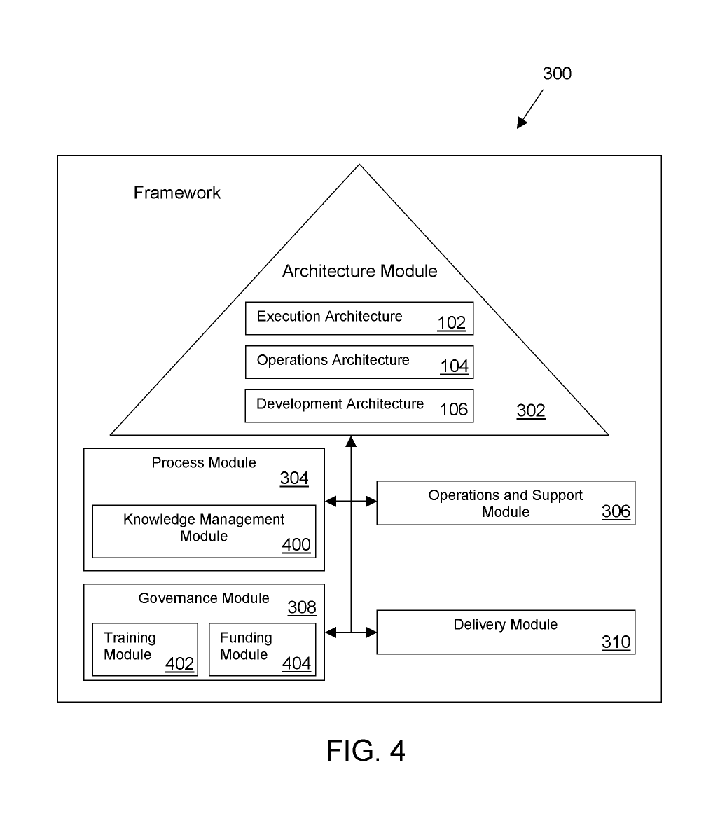

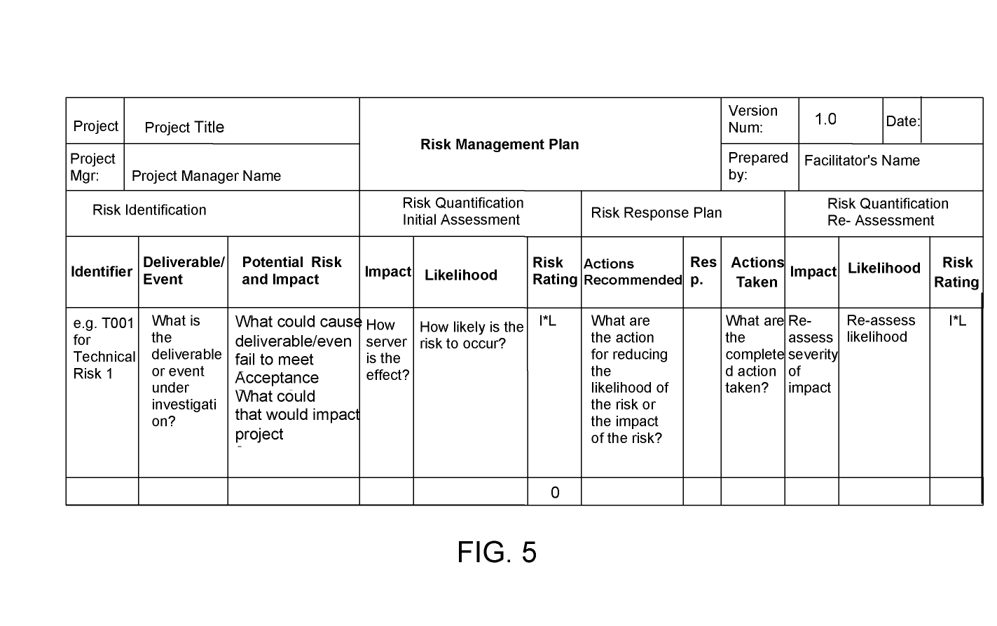

Process module 304 manages processes that are implemented to provide the BI solution. Process module 304 manages the processes, based on architecture module 302. The processes may include developing, upgrading, testing, deploying, and configuring management, risk management, change management and release management associated with framework 300. Further, the processes may be defined to provide production support, problem management, the support-team structure, quality assurance and the implementation of pilot projects. Furthermore, process module 304 provides templates, standards, policies and guidelines that are required for implementing execution architecture 102. An exemplary risk management template has been explained in conjunction with FIG. 5. In accordance with an embodiment of the invention, process module 304 defines the processes for integrating the existing projects of the organization with framework 300. Process module 304 includes a Knowledge Management (KM) module for knowledge maintenance and development. The knowledge management module is explained in conjunction with FIG. 4.

Operations and support module 306 manages the infrastructural requirements of framework 300, based on architecture module 302. Examples of infrastructural requirements may include, but are not limited to, infrastructure development, capacity planning and environment provisioning of the BUs. Further, operations and support module 306 monitors and manages production environment of the BUs and standardized BI tools. Operations and support module 306 also defines and monitors Service Level Agreements (SLAs) and tracks software licenses.

Governance module 308 manages the organizational requirements related to the implementation of framework 300. These organizational requirements are managed, based on architecture module 302. Further, governance module 308 defines the metrics for measuring the performance of the BUs. The performance may be measured periodically, for example, every month, quarterly, and the like. Furthermore, governance module 308 defines the organization's structure, such as roles and responsibilities in the organization. Additionally, governance module 308 manages different initiatives in the organization and interfaces between the different teams in the organization. Governance module 308 may manage the risk associated with implementing framework 300. In accordance with an embodiment of the invention, governance module 308 ensures that framework 300 runs smoothly with adequate resources and control, which, in turn, helps to reduce the Total Cost of Ownership (TCO). For example, an employee of a pharmaceutical company may want to work on a new formula for a drug. However, it may be possible that another division of the company has already conducted research on a similar drug formula, i.e., a drug definition may already exist. Hence, the employee can avoid performing redundant research and work on the already existing drug definition by implementing framework 300. Further, governance module 308 will help the employee to decide whether the drug should be defined as an organization-level object or a division-level object. Governance module 308 provides a portal for mitigating such issues. Furthermore, if the drug is defined as a division-level object, it should coexist with other organization-level objects. This is achieved by using standard templates provided by process module 304. In accordance with an embodiment of the invention, governance module 308 includes a funding module and a training module. The funding module and the training module are explained in conjunction with FIG. 4.

Delivery module 310 manages the delivery of the processed business data to the BUs. In accordance with an embodiment of the invention, delivery module 310 manages end-to-end delivery of the processed business data. Further, delivery module 310 may implement quality audits and improvement initiatives, based on the requirements of the BUs. In accordance with an embodiment of the invention, delivery module 310 may develop and manage tools for testing and deployment, in conjunction with architecture module 302.

In accordance with various embodiments of the invention, process module 304, operations and support module 306, governance module 308 and delivery module 310 are integrated with architecture module 302. This integration provides an optimal and efficient BI solution that conforms to the requirements of the BUs.

FIG. 4 is a block diagram of framework 300 for managing Business Intelligence (BI) at an organization level, in accordance with another embodiment of the invention. Framework 300 includes architecture module 302, process module 304, operations and support module 306, governance module 308 and delivery module 310. Process module 304 includes a Knowledge Management (KM) module 400. Governance module 308 includes a training module 402 and a funding module 404.

KM module 400 provides KM tools for managing knowledge associated with the Bus, which, in turn, is used to provide the BI solution. KM module 400 defines a KM framework for the organization, taking into account the requirements of the BUs. In accordance with an embodiment of the invention, KM module 400 is periodically updated by incorporating the learning from pilot projects. Further, training module 402 defines different training programs and educational workshops required for the implementation of framework 300. For example, training module 402 may design a program for training users on how to use the different BI tools available.

Governance module 308 includes funding module 404, which manages the funding requirements of the BUs. Funding module 404 develops an organization level funding model for different BI projects. In accordance with an embodiment of the invention, funding module 404 is based on a subscription-based funding model.

Framework 300, as described above, may be used for consulting, project planning and estimation. Further, it provides an optimal way of implementing BI solutions at an organization level, which can be used by different BUs. The implementation of BI at the organization level helps to reduce the TCO and makes the process effective.

In accordance with various embodiments of the invention, framework 300 and the different modules explained in FIG. 1-4 may be implemented as software and hardware modules, firmware, or a combination thereof.

FIG. 5 is an exemplary template 500, in accordance with another embodiment of the invention. Template 500 is defined by process module 304. In accordance with an embodiment of the invention, template 500 is a risk management template. Template 500 may be used by governance module 308 to manage the risk associated with implementing framework 300.

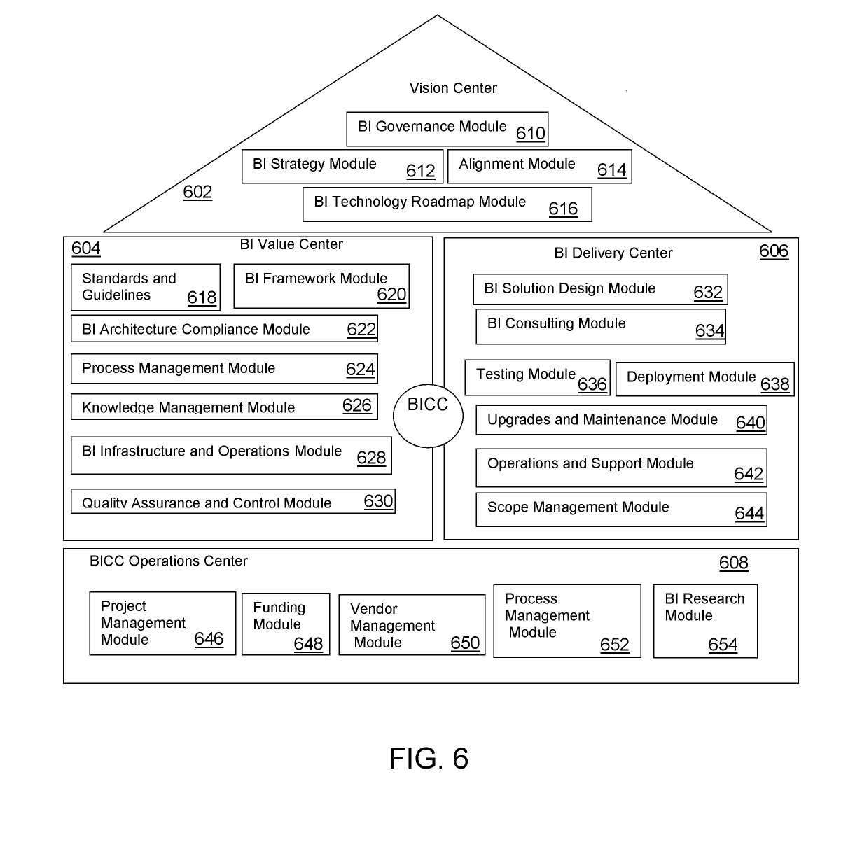

In accordance with an embodiment of the invention, framework 300 is used as a Business Intelligence Competency Center (BICC) to provide real-time BI solutions to the BUs. The BICC provides tools, frameworks, methodologies, guidelines and governance structures for implementing BI at an organization level. This is explained in detail in conjunction with FIG. 6.

FIG. 6 is a block diagram of a BICC 600 for managing Business Intelligence (BI) and providing BI solutions at an organization level, in accordance with an embodiment of the invention. BICC 600 includes a vision center 602, a BI value center 604, a BI delivery center 606 and a BICC operations center 608. Vision center 602 includes a BI governance module 610, a BI strategy module 612, an alignment module 614 and a BI technology roadmap module 616. BI value center 604 includes a standards and guidelines module 618, a BI framework module 620, a BI architecture compliance module 622, a process management module 624, a Knowledge Management (KM) module 626, a BI infrastructure and operations module 628, and a quality assurance and control module 630. BI delivery center 606 includes a BI solution design module 632, a BI consulting module 634, a testing module 636, a deployment module 638, an upgrades and maintenance module 640, an operations and support module 642, and a scope management module 644. BICC operations center 608 includes a project management module 646, a funding module 648, a vendor management module 650, a process management module 652, and a BI research module 654.

Vision center 602, BI value center 604, BI delivery center 606 and BICC operations center 608 function, based on an architecture. In one embodiment of the invention, this architecture is similar to architecture 100 or architecture module 302. In accordance with an embodiment of the invention, BICC 600 is a customized version of framework 300. For example, BICC 600 represents how a user can create, conceptualize and manage a BI request at the organization level.

Vision center 602 defines the BI vision of the organization, taking into account the objectives and information requirements at a project level and a Business Unit (BU) level. Vision center 602 defines the long-term architectural direction of the organization. BI Governance module 610 defines the roles, responsibilities and governance structures at the organization level in sync with the objectives and information requirements of the vision center 602. Further, BI governance module 610 may define the governance structures at the project and BU levels. BI governance module 610 is similar to governance module 308 and has been explained in detail in conjunction with FIG. 3.

BI strategy module 612 defines organization level strategies for different processes. For example, BI strategy module 612 defines sources of business data and metadata, and performs Extract Transform Load (ETL) functions. Further, BI strategy module 612 may define strategies for deploying reusable applications to facilitate sharing of resources across an organization. Furthermore, BI strategy module 612 may define strategies to enable existing projects to integrate with a framework such as framework 300. In accordance with an embodiment of the invention, BI strategy module 612 defines strategies for managing organizational changes in a structured and controlled manner by providing change and communication management strategies. BI technology roadmap module 616 also defines an architectural blueprint for implementing BICC 600. In other words, BI technology roadmap module 616 provides a technology architecture for executing a BI project. BI technology roadmap module 616 may be similar to technology module 110 and has been explained in detail in conjunction with FIG. 1 and FIG. 2. Alignment module 614 enables existing or in-flight projects to adopt a framework such as framework 300.

BI value center 604 represents the value proposition for users, i.e., how users can create value by using business data and BICC 600. Standards and guidelines module 618 of BI value center 604 defines standards and guidelines required for providing a BI solution. For example, standards and guidelines module 618 provides the templates required to implement BICC 600. BI framework module 620 defines the frameworks and patterns required to manage processes related to providing the BI solution. BI architecture compliance module 622 establishes, governs and maintains a uniform architecture across the organization. In other words, BI architecture compliance module 622 ensures that the processes and policies used to provide the BI solution are complaint with organization-level policies.

Process management module 624 defines the processes and guidelines for implementing BICC 600. Process management module 624 may be similar to process module 304 and has been explained in detail in conjunction with FIG. 3 and FIG. 4. Similarly, KM module 626 defines and maintains the KM tools required to provide the BI solution. KM module 626 may be similar to KM module 400 and has been explained in detail in conjunction with FIG. 4

In accordance with various embodiments of the invention, BI infrastructure and operations module 628 manages the infrastructural requirements of BICC 600. BI infrastructure and operations module 628 is based on architecture 100 or architecture module 302.

Quality assurance and control module 630 monitors the quality of business data and the BI solution. Quality assurance and control module 630 defines the evaluation procedures for checking the quality of business data and the BI solution. Quality assurance and control module 630 is similar to data quality module 208, explained in detail in conjunction with FIG. 2.

BI delivery center 606 defines the processes for managing the delivery of the BI solution, based on the requirements of the BUs. BI delivery center 606 is similar to delivery module 310, explained in detail in conjunction with FIG. 3 and FIG. 4. BI solution design module 632 defines the processes for processing a BI request and providing the BI solution. Further, BI solution design module 632 may facilitate the identification of BI applications and tools for providing the BI solution. Furthermore, BI consulting module 634 of BI delivery center 606 serves as an advisory council for providing the BI solution. For example, BI consulting module 634 may provide a user with a list of in-house experts or consultants in a particular domain.

Testing module 636 defines testing procedures for implementing BICC 600. Testing module 636 may be similar to testing module 216, which is explained in detail in conjunction with FIG. 2.

Deployment module 638 defines the configuration procedures for installing BI tools, which, in turn, are used to provide the BI solution. Further, deployment module 638 may define integrated monitoring processes for tracking the performance of BICC 600. Deployment module 638 may be similar to deployment module 214, as explained in detail in conjunction with FIG. 2. Upgrades and maintenance module 640 defines processes for maintaining and updating the BI tools used in BICC 600. For example, upgrades and maintenance module 640 may install a new version of different BI tools.

Operations and support module 642 defines different operations required to implement BICC 600. Operations and support module 642 is based on architecture 100 and architecture module 302, as explained in detail in conjunction with FIG. 1, FIG. 2 and FIG. 3. Further, operations and support module 642 may be similar to operations and support module 306, as explained in detail in conjunction with FIG. 3 and FIG. 4. Scope management module 644 defines guidelines and processes for defining the scope of BI requests. This scope is defined, based on the requirements of the BUs. The defined scope of the BI requests is used to provide the BI solution.

BICC operations center 608 defines the internal operations executed within the organization to implement BICC 600. Project management module 646 works in conjunction with deployment module 638, operations and support module 642 and scope management module 644, to define process guidelines and the scope for executing the BI project. Funding module 648 defines the funding requirements of BICC 600 and may be similar to funding module 402, as explained in detail in conjunction with FIG. 4. In an embodiment of the invention, funding module 648 also facilitates the process of estimating the budget requirements of the BI project.

Vendor management module 650 manages vendor-related data. Examples of such vendor-related data may include, but is not limited to, data about products provided by vendors and associated product technologies. This facilitates the identification of relevant vendors for a particular BI project. In an embodiment of the invention, vendor management module 650 may track the performance of different vendors.

Process management module 652 manages the internal processes of the organization. Examples of such internal processes may include managing the administrative requirements of BICC 600. Further, BI research module 654 facilitates proactive research in the latest technologies for reaping a maximum Return on Investment (ROI) on BICC 600.

The present invention provides a business-oriented competency framework for implementing BI solutions at an organization level. The BI solutions are implemented, taking into consideration information requirements and objectives at a BU and a project level. Hence, the alignment of the objectives at the project level and the BU level with those at the organization level reduces governance-related issues in the organization. Further, implementing the framework results in sharing of resources, knowledge and initiatives across the organization. Furthermore, the framework provides standard guidelines, processes, Service Level Agreements (SLAs), templates and methodologies. This results in reduction of redundant work, reusability of business data, reduced total cost of ownership, and shorter delivery cycles. Another advantage of the present invention is that it provides supporting architectures such as an operations and a development architecture for facilitating the functioning of an execution architecture. Further, the framework is scalable and flexible to the changing requirements of the organization. Hence, the framework provides the BI solutions in an efficient and optimal manner.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. An architecture for managing Business Intelligence (BI) for an organization, the organization comprising a plurality of business units, the architecture comprising:
a. an execution architecture, the execution architecture comprising:
i) a data module configured to define methodologies to process business data related to requirements of at least one of the plurality of business units; and
ii) a technology module configured to define at least one technology platform required for implementing the architecture;
b. an operations architecture, the operations architecture defining procedures and policies for processing requirements of at least one of the plurality of business units, the operations architecture comprising:
i) a recovery module configured to define backup and recovery procedures for the business data and a BI solution generated by the architecture; and
ii) a monitoring module configured to track usage of the architecture;
c. a development architecture, the development architecture comprising:
i) a development tools module configured to standardize tools required for implementing the BI solution; and
ii) an installation module configured to manage configuration procedures of the architecture.

2. The architecture according to claim 1, wherein the business data comprises at least one of financial data, technical data, product data, customer data, competitor data, employee data and operational details of at least one of the business units.

3. The architecture according to claim 1, wherein the at least one technology platform comprises at least one of On-line Analytical Processing (OLAP), Extract Transform Load (ETL), Enterprise Application Interfaces (EAI), Enterprise Information Interfaces (EII), and operating systems, networks, interfaces and relational databases required for implementing the architecture.

4. The architecture according to claim 1, wherein the execution architecture further comprises a product module configured to evaluate at least one product related to BI, the at least one product being evaluated based on requirements of at least one of the plurality of business units.

5. The architecture according to claim 1, wherein the data module comprises an analysis engine configured to generate at least one report, the at least one report comprising analysis of the business data based on requirements of at least one of the plurality of business units.

6. The architecture according to claim 1, wherein the data module comprises a metadata module configured to manage metadata, wherein the metadata is related to at least one of the business data, technical data and operational data, the technical data and the operational data being related to at least one of the plurality of business units.

7. The architecture according to claim 1, wherein the data module comprises a transport module configured to manage transportation of the business data.

8. The architecture according to claim 1, wherein the data module comprises an Extract Transform Load (ETL) module configured to define at least one business rule, the at least one business rule being used for processing the business data.

9. The architecture according to claim 8, wherein processing the business data comprises at least one of creating dimensions for the business data, applying transformations to the business data, formatting the business data, preparing content and structure of reports associated with the business data.

10. The architecture according to claim 1, wherein the data module comprises a data quality module configured to monitor quality of the business data based on requirements of at least one of the plurality of business units.

11. The architecture according to claim 1, wherein the monitoring module comprises a deployment module configured to install and maintain the tools required for implementing the BI solution.

12. The architecture according to claim 1, wherein the monitoring module is further configured to generate security-related alerts for at least one of the plurality of business units.

13. The architecture according to claim 1, wherein the development tools module is further configured to standardize Development Environment (DE) required for developing the architecture.

14. The architecture according to claim 1, wherein the development architecture comprises a testing module configured to standardize at least one testing process associated with the architecture.

15. A framework for managing Business Intelligence (BI) for an organization, the organization comprising a plurality of business units, the framework comprising:
a. an architecture module configured to define the framework at the organization level, the architecture module comprising:
i) an execution architecture configured to process business data related to requirements of at least one of the plurality of business units;
ii) an operations architecture configured to define procedures and policies to manage operations of at least one of the plurality of business units; and
iii) a development architecture configured to facilitate deployment of the framework based on requirements of at least one of the plurality of business units;
b. a process module configured to manage processes based on the architecture module, the processes being implemented by at least one of the plurality of business units;
c. an operations and support module configured to manage infrastructural requirements of the framework based on the architecture module;
d. a governance module configured to manage organizational requirements related to implementing the framework, the organizational requirements being managed based on the architecture module; and
e. a delivery module configured to manage delivery of the processed business data to at least one of the plurality of business units, wherein the processed business data is delivered based on the architecture module.

16. The framework according to claim 15, wherein the business data comprises at least one of financial data, technical data, product data, customer data, competitor data, employee data and operational details of at least one of the business units.

17. The framework according to claim 15, wherein the process module is further configured to provide at least one of templates, standards, policies and guidelines required for implementing the framework.

18. The framework according to claim 15, wherein the process module comprises a Knowledge Management (KM) module configured to provide KM tools, the KM tools being used for managing knowledge associated with at least one of the plurality of business units.

19. The framework according to claim 15, wherein the operations and support module is further configured to monitor at least one of Service Level Agreements (SLAs) and software licenses associated with at least one of the plurality of business units.

20. The framework according to claim 15, wherein the infrastructural requirements comprise at least one of infrastructure development, capacity planning and environment provisioning of at least one of the plurality of business units.

21. The framework according to claim 15, wherein the governance module is further configured to define at least one metric for measuring performance of at least one of the plurality of business units.

22. The framework according to claim 15, wherein the governance module comprises a funding module configured to manage funding requirements of at least one of the plurality of business units.

23. The framework according to claim 15, wherein the governance module comprises a training module configured to manage training for at least one of the plurality of business units based on requirements defined by the architecture module.
